(19) United States
(12) Patent Application Publication
(10) Pub. No.: US 2014/0127475 A1
(43) Pub. Date: May 8, 2014

(54) Paper corrugated sheet

(71) Applicant: Daniel James Bonebrake, Salem, OR (US)

(72) Inventor: Daniel James Bonebrake, Salem, OR (US)

(21) Appl. No.: 14/155,238

(22) Filed: Jan. 14, 2014

Related U.S. Application Data
(63) Continuation-in-part of application No. 13/591,956, filed on Aug. 22, 2012, now Pat. No. 8,662,380.

(51) Int. Cl. B32B 3/28; B32B 29/00

(52) U.S. Cl. CPC B32B 3/28; B32B 29/005
USPC 428/186

(57) ABSTRACT

The inventive paper corrugated sheet is used to construct an improved modular corrugated crate that is reusable, recyclable, and biodegradable. The paper corrugated sheet is constructed from a laminated paper combination of aligned fluted paper and linerboard adhered together by adhesive. The sheet is constructed with a generally decreasing weight in laminated paper components from the outside of the paper corrugated sheet to the interior side, thereby improving strength and increasing the number of times that the crate can be reused.

### CROSS REFERENCE TO RELATED APPLICATION

This application is a continuation-in-part of application Ser. No. 13/591, 956 filed on Aug. 22, 2012.

### GOVERNMENT INTEREST STATEMENT

None

### DESCRIPTION

1. Field of the Invention

The present invention is related to shipping crates and, more specifically, to corrugated sheets constructed of paper pulp components that are used to fabricate modular corrugated crates. Such modular corrugated crates are lightweight, recyclable, durable, reusable, and have a stackable compression strength exceeding one hundred times the weight of the assembled crate.

2. Brief Description of the Prior Art

Storage and disposal of used shipping crate waste is a significant expense for many businesses that receive or send articles in shipping crates. Historically, shipping crates were made from wood, which uses up natural resources, are relatively expensive to construct, difficult to breakdown, and generally are not recyclable or reusable. Corrugated paper mediums as used in constructing shipping crates are gaining popularity as a better environmental option, but generally are limited in application because of the corrugated paper mediums having susceptibilities to degradation in strength, complications in assembly, and so damaged during unpacking or break down that the entire crating materials must be disposed of as waste after only one use further exasperating the waste problem.

Using a corrugated paper crate for shipping larger or heavier items is a relatively new crating option when compared to the use of wooden crates. The durability of the corrugated paper crate was a previous set back to it's accepted use. Also, commonly endured shipping conditions made corrugated paper crates susceptible to failures. Reusing a corrugated paper crate after it was shipped, torn open, and the cargo removed was not possible nor seemed feasible until recently.

As such, there is a need not satisfied by the prior art for a resilient corrugated sheet constructed of paper that is not only durable, strong, and able to be made moisture resistant, but also suitable for being used more than once, thereby decreasing crating waste while providing an environmentally sustainable solution to paper based crating challenges into the future.

### SUMMARY OF INVENTION

The invention relates to a modular shipping crate constructed from laminated paper materials, and in particular, to a paper corrugated sheet constructed from a laminated combination of fluted paper and linerboard. The paper corrugated sheets are used to construct the crate, with some crate components having two or more inventive sheets cross laminated together for increased strength at critical areas. The resilient nature of the paper corrugated sheet allows the crate or it's components to be used multiple times before having to be disposed of as waste. After it's usable life exhausted, the paper corrugated sheet is biodegradable or recyclable. When the inventive sheets are constructed into a modular shipping crate, the crate has a stackable compression strength exceeding one hundred times the weight of the assembled crate and is reusable. The significance of reducing shipping crate waste by having a paper corrugated sheet that can withstand the rigors of being formed, crated, shipped, uncrated, and stored for the next crate assembly can't be understated, for every crate reused, is one less crate manufactured from limited resources, and one less crate waste that needs disposing of.

The improved paper corrugated sheet folds, or bends more easily towards its interior side than its exterior side. When constructed into a crate, the resiliency of the paper corrugated sheet increases the number of times that a particular modular corrugated crate or component can be used. The inventive sheet provides an improved and more durable crate construction material, especially at each corner of the crate. To explain, the corrugated modular crate design has folding components at each corner that crushingly fit together when assembled. The inventive sheet when bent or folded towards its interior side, it bends or folds easier as formed, and benefits from an increased resiliency and greater durability allowing for multiple uses. Further, the inventive sheets when cross laminated with other sheets to build components of the crate provide enhanced structural integrity without increasing the weight or expense, while still benefitting from the improved durability at each corner.

### BRIEF DESCRIPTION OF THE DRAWINGS

FIG. 1 is a perspective exploded view of a preferred embodiment of the invention as constructed into a modular corrugated shipping crate;

FIG. 2 is an enlarged sectional top view of one corner of one end panel depicted in FIG. 1;

FIG. 3 is top down illustration of the end panel and side panel fittingly assembled;

FIGS. 4 is a top down view of the side panel and end panel illustrating the crushing fit;

FIG. 5 is an end view demonstrating the various lamination layers of the inventive corrugated sheet;

FIG. 6 is an perspective end view of another embodiment of the inventive corrugated sheet;

FIG. 7 is an enlarged sectional top view of one corner of one end panel first depicted in FIG. 2, shown in FIG. 7 as constructed from three inventive corrugated sheets.

### DETAILED DESCRIPTION OF THE DRAWINGS

The inventive corrugated sheet is constructed from paper pulp products, adhered by adhesives, and suitable for constructing a modular corrugated reusable crate. The elements used to construct the inventive sheet includes a core constructed of fluted sheets and middle linerboards, with an outer and inner paper linerboard on each side of the core, all adhered by a suitable adhesive, with the exterior coated with a moisture barrier to improve water resistance,

There are several common flute types, A-Fluting that has 110-120 flutes per meter having a height of 4.0-4.8 mm; C-Fluting that has 127-140 flutes per meter and a height of 2.8-3.7min; B-Fluting that has 150-167 flutes per meter and a height of 1.8-2.5; and E-Fluting that has 295-327 flutes per meter and a height of 1.5-1.8 mm. A less common type of fluting but currently available in the United States is called L-Fluting, L-Fluting has 80-90 flutes per meter having a height of 7.0-9.0 mm. Linerboard materials are generally characterized by their relative weight per square area, and commonly range from 23-lb to 69-lb/1,000 ft2.

The adhesive used to adhere the paper elements together may be of many suitable types, examples being DX03 by Wisdom Adhesives, Bio-Based adhesives by VTT., and Biodegradeable Laminates by Drytac®. The preferred adhesive being biodegradable, durable when crushed, folded, or deformed, and resistant to moisture or wet conditions after curing.

The exterior coating used to protect the sheet from high humidity or wet conditions can be of many suitable types, the preferred water resistant treatment being a ClimaCoate® barrier coating by International Paper.

The identified paper type, adhesive, and exterior coating products are disclosed specifically so that one skilled in this art is fully enabled to make and use that which is claimed herein. However, the above specific disclosure in no way limits applicant's invention, as many suitable products are suitable.

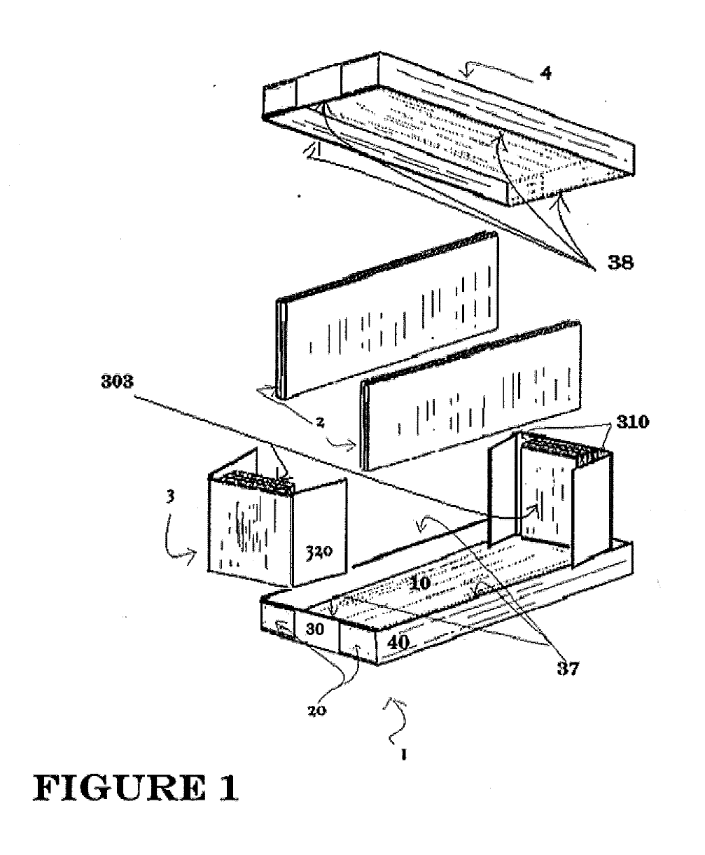

As shown in FIG. 1, the modular corrugated reusable crate has six discrete components, a bottom base 1 with side tabs 40 and end tabs 30 compressively interconnecting at the corners and fixated with a plurality of through fasteners thereby defining the bottom lip 37. The bottom lip 37 circumscribes the center base section 10 and holds together the end panels 3 and side panels 2 when assembled. The center base section 10 is at least two corrugated sheets thick with the option of adding additional sheets to increase rigidity. Each end tab 30 and edges of the center base section 10 are compressively held by the side tabs 40 when the side tabs 40 are folded up. The inventive corrugated sheet allows for a more resilient ‘crushing to fit’ along the mating edges of the side tabs 40 and end tabs 30, thereby making for a tighter tolerance fit use after use, with more durable characteristics provided by the paper based laminated construct.

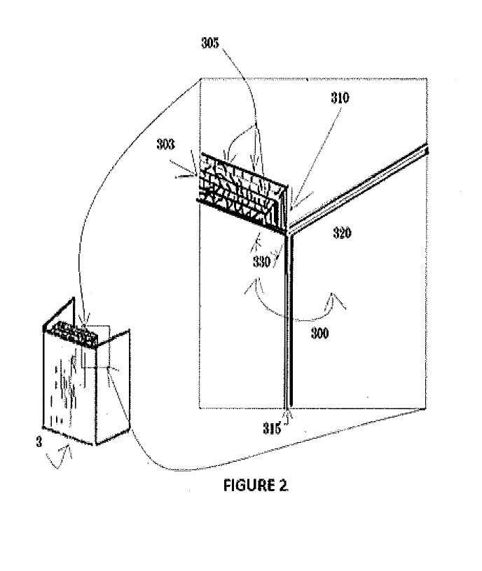

As shown in FIG. 2, the end panel 3 has at least one continuous exterior side sheet 300 constructing the corner tab 320 that swingably hinges around the corner fold axis 315. A center section 303 is shown as being constructed from several corrugated side sheets 305 that are laminated together. Obviously the center section 303 does not have a hinge deformation, or is subject to folding, but the center section 303 does provide a significant portion of the rigidity strength for the assembled crate. As depicted in FIG. 2, the exterior side sheet 300 is folded along the fold axis 315 to form the corner tab 320 which swings about the fold axis 315 much line a hinge. The strength and durability of this hinge like structure along the fold axis 315 is wholly determined from the construction of the continuous exterior side sheet 300.

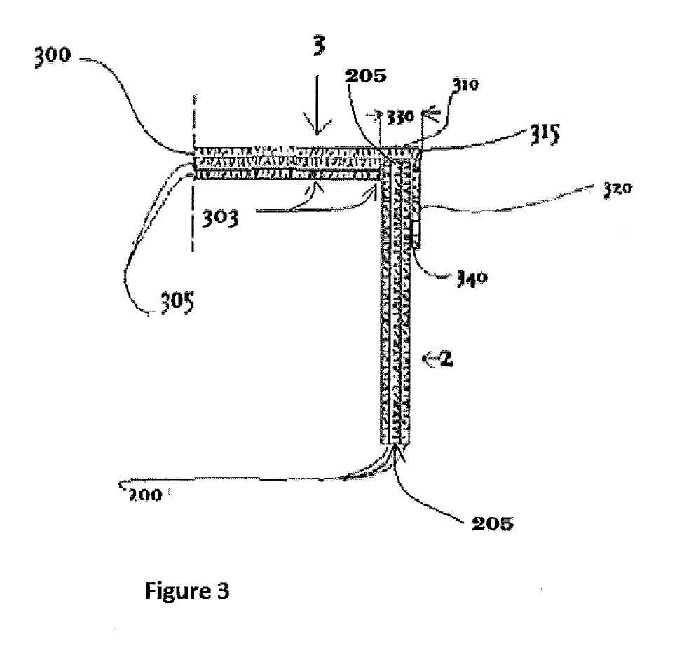

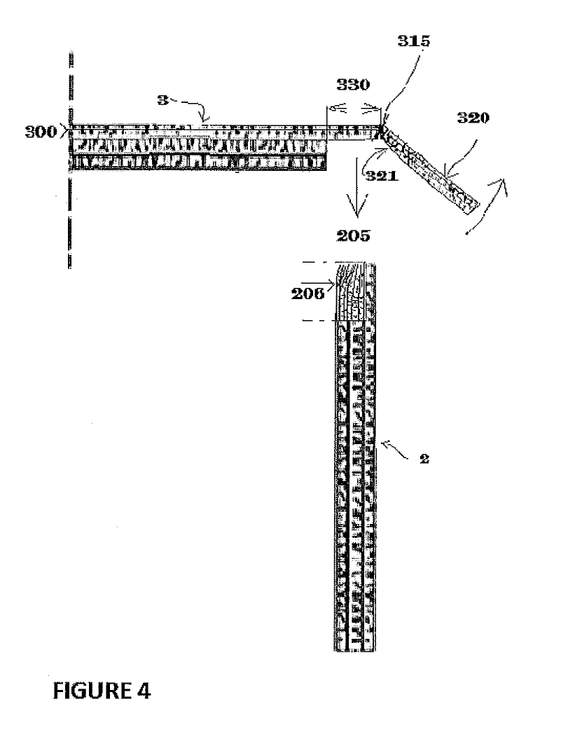

As shown in FIGS. 2 and 4, when the corner tab 320 is swung about the fold axis 315 during assembly or disassembly, the paper materials along the fold axis 315 are deformed, stressed and damaged by the swinging motion. The exterior side sheet 300 along fold axis 315 on the interior side of the swing adjacent to the side interlock 310 which is effectively compressed or crushed, while the outside of the exterior side sheet 300 along the fold axis 315 is effectively expanded or stretched. To help explain the importance of the fold axis 315 one must understand that the fold axis 315 works cooperatively to provide a tight tolerance fit at the side interlock 310 with the side panels 2 shown in FIG. 3. However, the more times that the corner tab 320 swingably hinges, crushes, and pivots around the corner fold axis 300, the more damage the exterior side sheet 300 receives.

As shown in FIG. 3 with the crate assembled, the side panel 2 fittingly inserts between the corner tab 320 and center section 303 until the side panel's 2 end abuts the side interlock 310. As the corner tab 320 hinges about its axis defined by the corner fold 315 and placed into bottom base 1 (shown in FIG. 1) then side panel 2 is dropped in from above and then the corrugate material of the corner tab 320 crushes, thereby compressively securing the components fixedly together making for a precise fit. The deformed or crushed corrugated sheet allows for a friction tight fit of the components when assembled into a shipping crate, and the resiliency of the paper corrugated sheet allows for multiple uses.

As shown in FIG. 4 from the top perspective, the end panel 3 is shown having the corner tab 320 swung open illustrating the crushed tab section 321 that appears to remain deformed after disassembly. Said crushed tab section 321 compressively fitted as against the side panel 2 crushing slightly to secure the side panel 2. The side panel 2 also is illustrated in detail showing the crushed side panel 206 fittingly inserts and crushingly fits within the interlock width 330. The side panel 3, interlock width 330, and corner tab 320 achieve greater fit tolerances with the side panel 2 if the corrugated sheets from which they are constructed minimally deform, and resiliently hold shape use after use. To example by detail, the crushed side panel 206 and crushed tab section 321 illustrates how the crushed corrugated material compressively forms and securely fits together to make a zero tolerance fit, however after use, the fit is looser as the corrugated sheets lose their resiliency, form, and structural integrity.

In FIG. 3-4 the detail of the crushed side panel 206 and crushed tab section 321 clearly examples the challenge in reusing corrugated paper components as a shipping container. After just one use, the crate's modular components show damage where the corrugated sheet is bent, folded, or crushed during the assembly of the crate, damaged by the environment in shipping, and damaged again when opened and the shipped articles removed. It is recognized that mediums other than corrugated cardboard or paper board can be used, but the benefits of a medium made entirely of paper is preferred because of its relative light weight, biodegradable disposal options, 100% recyclable, and availability of recycled paper products.

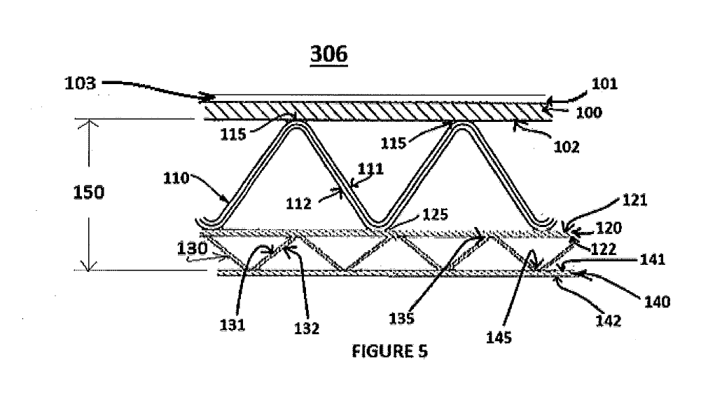

As shown in FIG. 5, the preferred embodiment of the paper corrugated sheet 306 is illustrated from a cutaway sectional end view demonstrating the various lamination layers, constructed having a core 150 of laminated fluted sheets 110 & 130 and middle paper linerboards 120, the core 150 being sandwiched between a heavier weight outer paper flat linerboard 100 and a lighter weight interior flat linerboard 140. The outer paper flat linerboard 100 as shown having a coating of a moisture barrier 103 on it's first surface 101, thereby protecting the assembled crate from environmental conditions. For wet or moist articles such as vegetables or fruit a coating of moisture barrier 103 may be applied to the second surface of the interior flat linerboard 140. (Not Shown).

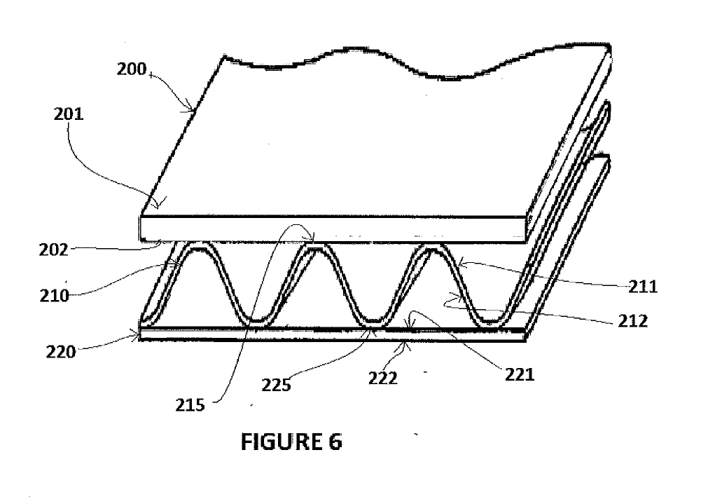

As shown in FIGS. 5 and 6, and described herein, relative weights of the paper sheets are configured such that the heaviest weighted paper mediums are located on the outer layers, and lighter weight paper on the interior layers. Similarly, the relative size of the fluting sheets are configured with the largest fluting located at the outer layers and smaller fluting at the interior layers of the core 150. Further, the fluting orientation of the paper corrugated sheet 306 are aligned, not perpendicular, and not cross laminated. By orientating the outer fluted sheet 110 and inner fluted sheets 130 as aligned, bending or shaping the paper corrugated sheet 306 along a fold line that parallels the fluting is done with less force, and thus less damage to the paper materials than if bent at a right angle with the fluting oriented in the most common orientation which is for added cross laminated strength, being oriented perpendicular. The declining weights of paper flat linerboard from outside to the inside further decreases forming forces, and provides the result of a more resilient crate component after forming, and more durable after a plurality of uses. Finally, the smaller fluting towards the inner side provides an easier and more resilient crush area at the interior angle of the bend as shown in FIG. 4.

As shown in FIG. 5, starting from the exterior side and describing toward the interior side, an outer paper flat linerboard 100 with weight of at least 35 lb/1,000 ft2 having first 101 and second 102 surfaces. Next is an outer fluted sheet 110 with A-Fluting having first 111 and second 112 surfaces, the first surface 111 of the outer fluted sheet 110 being adhered 115 by an adhesive to the second surface 102 of the second surface 102 of the outer paper flat linerboard 100. The next layer is a middle paper flat linerboard 120 with a weight less than the outer paper flat linerboard 100 having first 121 and second surfaces 122, the first surface 121 of the middle paper flat linerboard 120 being adhered 125 by an adhesive to the second surface 112 of the outer fluted sheet 110. The next fluted layer is an inner fluted sheet 130 with smaller fluting than the outer fluted sheet 110 having first surface 131 and second surface 132, the first surface 131 of the inner fluted sheet 130 being adhered 135 by an adhesive to the second surface 122 of the middle paper flat linerboard 120 such that the inner fluted sheet 130 and outer fluted sheet 110 have parallel fluting when constructed into the preferred embodiment of the paper corrugated sheet. The outer fluted sheet 110, the middle paper flat linerboard 120, and the inner fluted sheet 130 when laminated together is referred herein as the core 150, which may further include a multitude of additional flute/linerboard combinations to achieve the desired thickness or structural strength. The last layer is an inner paper flat linerboard 140 with the same or less weight than the core's middle paper flat linerboard 120, the inner paper flat liner board 140 having a first surface 141 and second surface 142, the first surface 141 of the inner paper flat linerboard 141 being adhered 145 by an adhesive to the second surface 132 of the inner fluted sheet 130 to form the preferred paper corrugated sheet.

To help explain the advantage, by generally decreasing paper weight from the outer paper flat linerboard 100 to the inner paper flat linerboard 140 allows the paper corrugated sheet to bend or fold with greater ease, and less permanent deformation when constructed into a modular crate component. The lighter paper bends and bends back easier than the heavier paper, and when formed in a bend or fold the lighter paper receives less permanent damage than the heavier paper, especially when the bend or fold has a relatively tight radius. The heavier paper flat linerboard located on the outside or exterior side of the sheet undergoes a larger fold radius or less deformation when forming to achieve the desired angle than does the interior portion of the sheet which undergoes a much greater crush at the tighter interior radius of fold. The heavier paper flat board liner on the exterior radius is less damaged by the forming, thereby resulting in a stronger shipping crate when assembled, and a more durable crate that retains its strength rating even after multiple uses.

The inventive corrugated sheet shown illustratively in FIG. 5 is able to be folded or bend to a 90 degree angle with less force than a corrugated sheet constructed from paper materials that all have the same weight, or same fluting. Normal crate opening and breakdown inflicts upon the crate components bending, folding, and deforming, which all cause damage. This type of damage is reduced when the crate is constructed from the inventive corrugated sheet because the crate components take less force to open and handle. Further, when reusing the crate the components they assemble with less force, require less shimming to retain tight tolerance, and the overall decrease in crate component wear and tear increases the crate's useful life.

In another embodiment of the inventive paper corrugated sheet shown in FIG. 6, the number of paper medium layers is reduced from five to three and is depicted diagrammatically in FIG. 6 as a cutaway sectional end view demonstrating the various lamination layers. The three layer embodiment includes an outer paper flat linerboard 200 with weight of at least 35 lb/1,000 ft2 having first 201 and second 202 surfaces. A single fluted sheet 210 with L-Fluting having first 211 and second 212 surfaces, the first surface 211 of the outer fluted sheet 210 being adhered 215 by an adhesive to the second surface 202 of the outer paper flat linerboard 200. The final layer is an interior paper flat linerboard 220 with a weight less than the outer paper flat linerboard 200 having first 221 and second surfaces 222, the first surface 221 of the interior paper flat linerboard 220 being adhered 225 by an adhesive to the second surface 212 of the single fluted sheet 210.

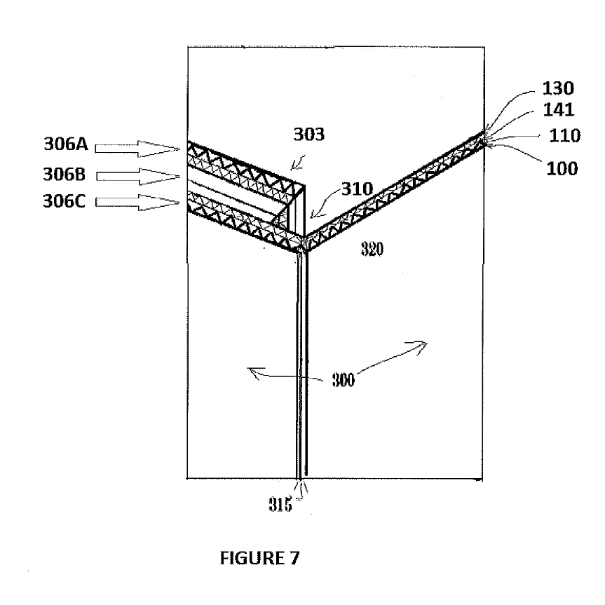

As shown in FIG. 7, the end panel 3 first depicted in FIG. 2, now shown constructed from the preferred paper corrugated sheet shown in FIG. 5, includes preferred embodiments of the inner sheet 306A, middle sheet 306B, and outer sheet 306C. The inventive exterior side sheet 300 depicted in FIG. 2 is constructed from the outer sheet 306C, that is folded or formed along the fold axis 315 as bent towards the interior side of the swing adjacent to the side interlock 310. The middle sheet 306B is cross laminated (fluting perpendicular to the outer sheet 306C) to the outer sheet 306C, with the inner sheet 306A laminated to the middle sheet 306B with the fluting in the same direction as the outer sheet 306C to construct the center section 303. When forming the corner tab 320 by bending the exterior side sheet 300 about the fold axis 315 the lighter paper materials from the inner fluted sheet 130 to the inner paper flat linerboard 141 crush and hold the desired form more easily and with less forming force than prior art lamination sheet constructs.

As discussed herein and exemplified by comparing FIG. 2 and FIG. 7, the strength and durability of the hinge like structure at each corner along the fold axis 315 is wholly determined from the construction of the continuous exterior side sheet 300. Damage to the outer paper flat linerboard 100 and the outer fluted sheet 110 are alleviated and reduced by the easier crushing laminated combination of the inner fluted sheet 130 inner paper flat linerboard 141, and middle paper flat linerboard 120. The resulting assembled crate is more durable allowing for multiple uses because of the stronger and more resilient crate corners due to the preserved uncrushed integrity and minimally deformed outer paper flat linerboard 100 and outer fluted sheet 110.

The described and shown embodiment, while illustrative of the invention, does not limit the present invention to the various embodiments described herein, but includes any and all embodiments having equivalent elements, modifications, omissions, combinations, adaptations and/or alterations as would be appreciated by those skilled in the art. The claims are to be interpreted broadly based on the language employed in the claims as defined by the specification, and not limited by the disclosure of specific embodiments, configuration, or illustrations herein.

What I claim is:

1. An improved paper corrugated sheet for constructing a modular corrugated reusable crate, comprising:
a core having at least one middle paper flat linerboard alternatively adhered between at least two fluted sheets, each fluted sheet having the same fluting orientation;
an outer paper flat linerboard having first and second surface and a weight greater than the middle paper linerboard, and an inner paper flat linerboard with the same or less weight than the middle paper linerboard, the outer paper flat linerboard and inner paper flat linerboard being adhered on opposing sides of the core having the first surface of the outer paper flat linerboard being the exterior of the improved paper corrugated sheet.

2. An improved paper corrugated sheet for constructing a modular corrugated reusable crate, comprising:
an outer paper flat linerboard with weight of at least 35 lb/1,000 ft2 having first and second surfaces;
an outer fluted sheet with A-Fluting having first and second surfaces, the first surface of the outer fluted sheet being adhered by an adhesive to the second surface of the outer paper flat linerboard;
a middle paper flat linerboard with a weight less than the outer paper flat linerboard having first and second surfaces, the first surface of the middle paper flat linerboard being adhered by an adhesive to the second surface of the outer fluted sheet;
an inner fluted sheet with smaller fluting than the outer fluted sheet having first and second surfaces, the first surface of the inner fluted sheet being adhered by an adhesive to the second surface of the middle paper flat linerboard;
an inner paper flat linerboard with the same or less weight than the middle paper flat linerboard having first and second surfaces, the first surface of the inner paper flat linerboard being adhered by an adhesive to the second surface of the inner fluted sheet to form an improved paper corrugated sheet.

3. An improved paper corrugated sheet for constructing a modular corrugated reusable crate, comprising:
an outer paper flat linerboard with weight of at least 35 lb/1,000 ft2 having first and second surfaces;
an middle fluted sheet with L-Fluting having first and second surfaces, the first surface of the middle fluted sheet being adhered by an adhesive to the second surface of the outer paper flat linerboard;
an inner paper flat linerboard with a weight less than the outer paper flat linerboard having first and second surfaces, the first surface of the inner paper flat linerboard being adhered by an adhesive to the second surface of the middle fluted sheet to form a resilient corrugated sheet.

4. The improved paper corrugated sheet for constructing a modular corrugated reusable crate of claims 1, wherein the core is constructed from at least two fluted sheets having differing fluting size, the sheet with the largest fluting arranged to be closest to the outer paper flat linerboard.

5. The improved paper corrugated sheet for constructing a modular corrugated reusable crate of claim 1, 2 or 3, wherein the modular corrugated reusable crate's end panels are constructed from three improved paper corrugated sheets, an outer sheet, a middle sheet, and an inner sheet, the outer sheet having a corner tab, corner fold, and side interlock at each end with a center section there between, said center section further including the middle sheet and inner sheet laminated together with the outer sheet, such that the outer sheet's fluting parallels the corner fold, the middle sheet's fluting is perpendicular to the outer sheet, and the inner sheet's fluting parallels the fluting of the outer sheet.

6. The improved paper corrugated sheet for constructing a modular corrugated reusable crate of claim 1, 2 or 3, wherein the outer flat linerboard's first surface is coated with a water resistant barrier such that the crate when assembled has a moisture resistant exterior.

7. The improved paper corrugated sheet for constructing a modular corrugated reusable crate of claim 1, 2 or 3, wherein the inner flat linerboard's second surface is coated with a water resistant barrier such that the crate when assembled has a moisture resistant interior.
